(19) United States
(12) Patent Application Publication
(10) Pub. No.: US 2013/0224512 A1
(43) Pub. Date: Aug. 29, 2013

(54) JOINT BETWEEN SHEETS OF MATERIAL

(71) Applicants: Thomas Olin Zurfluh, Evanston, IL (US); Jonathan David Youngman, Ann Arbor, MI (US)

(72) Inventors: Thomas Olin Zurfluh, Evanston, IL (US); Jonathan David Youngman, Ann Arbor, MI (US)

(21) Appl. No.: 13/408,876

(22) Filed: Feb. 29, 2012

(51) Int. Cl. B32B 7/04; B32B 15/01; B23P 11/00; B32B 3/24

(52) U.S. Cl. 428/597; 428/133; 29/428

(57) ABSTRACT

Two sheets of material are positioned in overlying and parallel relationship with one another. Each of the sheets has a plurality of perforations with a tang extending from each perforation and the tangs of one sheet cooperate with the tangs of the other sheet to interconnect the sheets. At least one of the tangs on one of the sheets is a wide tang having a first width, and at least one of the tangs on the other of the sheets is a narrow tang having a second width which is less than the first width.

### BACKGROUND OF THE INVENTION

1. Field of the Invention

The present invention relates to joints between two or more sheets of material and a method of joining two or more sheets of material.

2. Related Art

Many automotive or non-automotive heat shields are formed of two or more metal (or non-metal) sheets positioned in parallel relationship with one another and joined together. The sheets may be interconnected with one another through a variety of different types of joints. For example, according to one known type of joint, the ends of one sheet are folded over the ends of the other sheet. According to another known type of joint, tangs having similar shapes and sizes are formed into each of the sheets, and the tangs are folded over one another so that they cooperate together to hold the sheets together.

### SUMMARY OF THE INVENTION

According to one aspect of the present invention, a joint is formed between first and second sheets of material overlying and in parallel relationship with one another. Each of the sheets has a plurality of perforations with a tang extending from each perforation, and the tangs of the first sheet cooperate with the tangs of the second sheet to interconnect the first and second sheets. At least one of the tangs on one of the sheets is a wide tang having a first width, and at least one of the tangs on the second sheet is a narrow tang having a second width which is less than the first width. The wide tang and narrow tang cooperate with one another to interconnect the first and second sheets with a gap provided therebetween.

The joint is beneficial because it produces a gap between the first and second sheets which improves the thermal resistivity of the joined sheets and also allows for easier bending and shaping of the joined sheets without crimping or otherwise damaging either sheet. Additionally, the joint can be formed more cheaply and easily than other known joints.

The first and second sheets could be of any type of formable material including, for example, various types of metals, plastics or composites. Additionally, the first and second sheets could be of different types of materials. The gap could be left empty or, if desired, it could be filled with a foam or any other type of material, which could further improve the thermal resistivity of the joined sheets.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective and elevation view of two sheets joined together to form a heat shield;

FIG. 2 is a perspective and elevation view of the exemplary first and second sheets;

FIG. 3 is an enlarged view of a wide tang and a narrow tang from one of the exemplary first sheet;

FIG. 4 is a perspective and sectional view of the exemplary heat shield;

FIG. 5 is a cross-sectional view of the exemplary heat shield taken along Line 5-5 of FIG. 4;

FIG. 6 is a cross-sectional view of the exemplary heat shield taken along Line 6-6 of FIG. 4;

FIG. 7 is a perspective and elevation view of an exemplary first roller and an exemplary second roller;

FIG. 8 is a schematic view of an arrangement for joining two sheets according to an exemplary embodiment of the invention; and

FIG. 9 is a flow chart of an exemplary method of joining two sheets.

### DETAILED DESCRIPTION OF THE ENABLING EMBODIMENTS

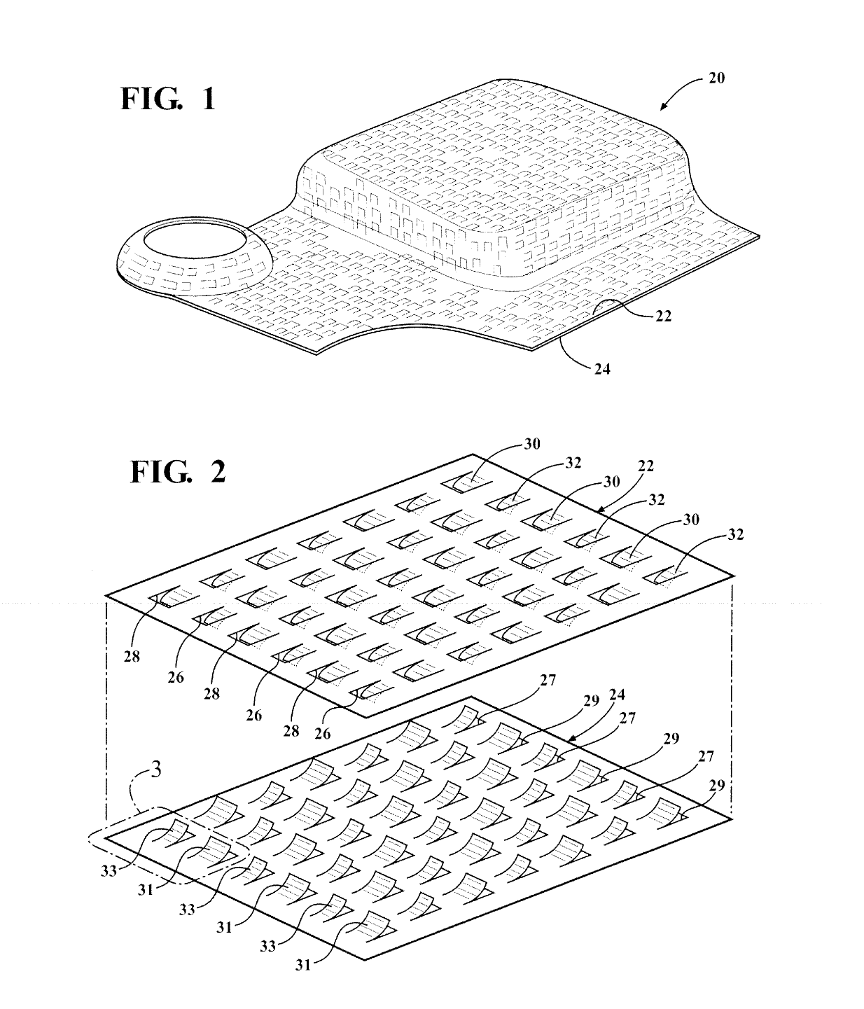

Referring to the Figures, wherein like numerals indicate corresponding parts throughout the several views, an exemplary heat shield 20 for the hot components of an engine or a vehicle formed from a first sheet 22 and a second sheet 24 joined to one another through a sheet metal joint is generally shown in FIG. 1. However, it should be appreciated that the joined sheets 22, 24 could find many other engine or vehicle or non-engine or vehicle applications. Additionally, the first and second sheets 22, 24 could be formed of any formable material including, for example, various types of metals, plastics or composites. Even further, the first and second sheets 22, 24 could be formed of different types of materials.

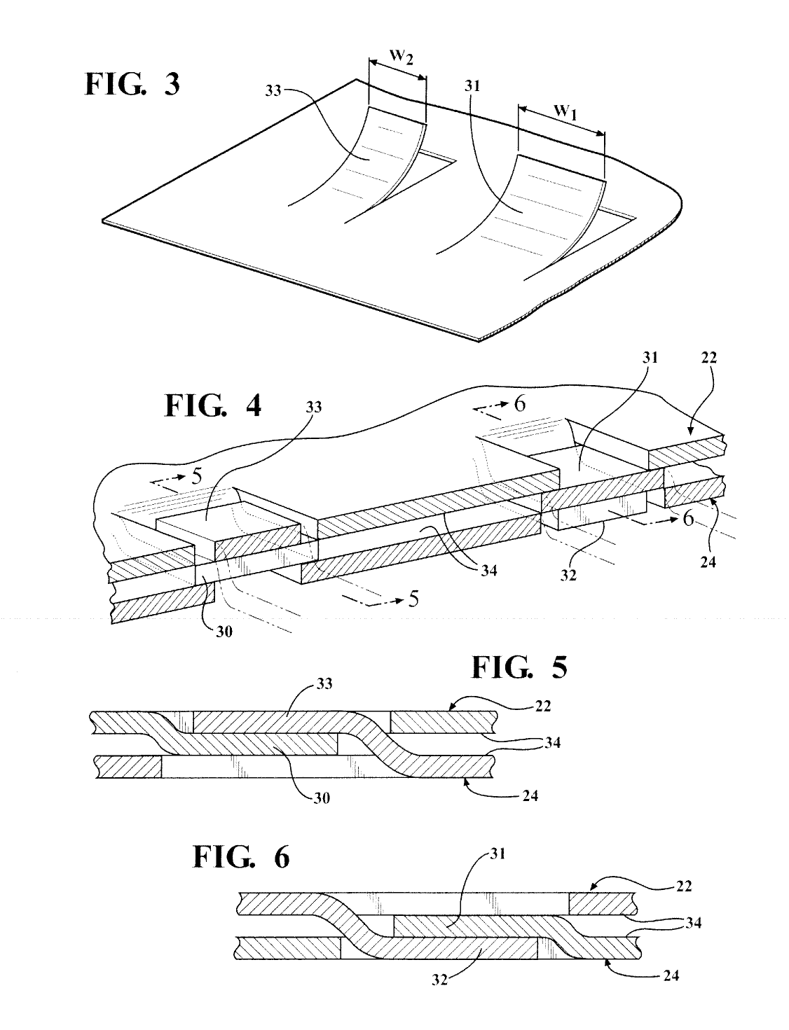

Referring now to FIG. 2, each of the sheets 22, 24 has a plurality of perforations 26, 27, 28, 29, and a tang extends generally upwardly from each such perforation 26, 27, 28, 29, having been formed therefrom. Each of the exemplary sheets 22, 24 includes both a plurality of wide tangs 30, 31 and a plurality of narrow tangs 32, 33. For example, an enlarged view of one of the wide tangs 30 and one of the narrow tangs 32, 33 is shown in FIG. 3. As shown, the exemplary wide tang 30 has a first width W₁ and the exemplary narrow tang 32 has a second width W₂ which is less than the first width W₁. Referring back to FIG. 2, the wide and narrow tangs 30, 31, 32, 33 of the exemplary sheets 22, 24 alternate with one another in both a lateral (widthwise) direction and a longitudinal (lengthwise) direction. However, it should be appreciated that a range of other arrangements of the tangs 30, 31, 32, 33 are contemplated. For example, the tangs 30, 31, 32, 33 could be arranged in any desirable pattern or each sheet 22, 24 could be composed of two or more pairs of different sized wide and narrow paired tangs such as having a greater number of relatively smaller tang pairs in areas subject to more severe forming during the heat shield manufacturing process or subject to more vibration during operation.

In the exemplary embodiment, all of the tangs 30, 31, 32, 33 have a generally rectangular shape and have generally similar lengths. However, it should be appreciated that the tangs 30, 31, 32, 33 could alternately have varying shapes and/or lengths. Another possibility is for one of the sheets 22, 24 to only have wide tangs 30, 31 and for the other sheet 22, 24 to only have narrow tangs 32, 33.

Referring now to the sectional views of FIGS. 4-6, the first and second sheets 22, 24 are joined to one another through the cooperation of the wide tangs 30, 31 of one sheet 22, 24 with the narrow tangs 32, 33 of the other sheet 22, 24 so that the sheets 22, 24 overly and are in generally parallel relationship to one another. Specifically, the wide tangs 30, 31 of one sheet 22, 24 are inserted between the corresponding narrow tangs 32, 33 and the remainder of the other sheet 22, 24. Such an interface between the cooperating tangs 30, 31, 32, 33 establishes a rigid connection between the first and second sheets 22, 24. Since the wide tangs 30, 31 are too wide to fit into the narrow perforations 26, 27, the sheets 22, 24 (apart from the tangs 30, 31 32, 33) remain spaced apart from one another by a gap which is sized approximately equal to the thickness of the wide tangs 30, 31. This gap 34 between the first and second sheets 22, 24 is hereinafter referred to as an “air gap 34”, although if desired, a foam or any other material could be inserted into the air gap 34. In the exemplary embodiment, the air gap 34 has the effect of increasing the heat shield's 20 thermal resistivity, thereby improving its performance. Additionally, the air gap 34 allows for improved bending or shaping of the joined sheets 22, 24 without crimping or otherwise causing damage to the first and second sheets 22, 24. Since the wide tangs 30, 31 obscure the narrow perforations 26, 27, there is no heat loss due to radiation as there would be if the tangs 30, 31, 32, 33 were of equal or lesser width and inserted into the perforations 26, 27, 28, 29 and folded backwards, thereby leaving an opening at each of the perforations 26, 27, 28, 29. It should be appreciated that some of the tangs 30, 31, 32, 33 of one sheet 22, 24 could cooperate with similarly sized tangs 30, 31, 32, 33 of the other sheet 22, 24 in areas where the air gap 34 is not desired.

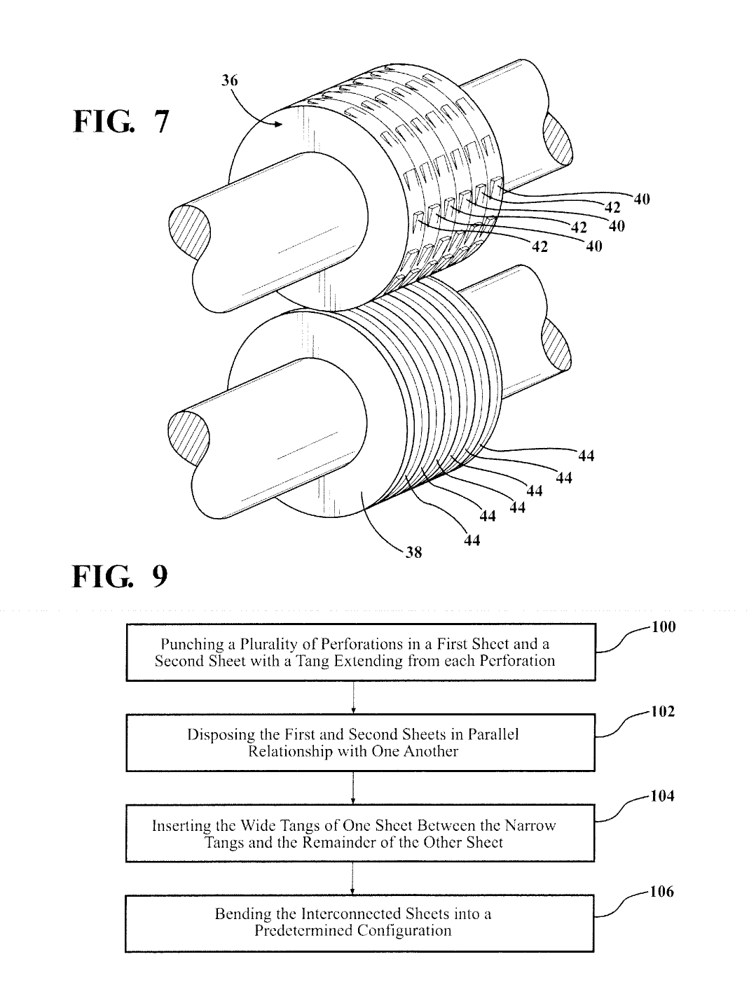

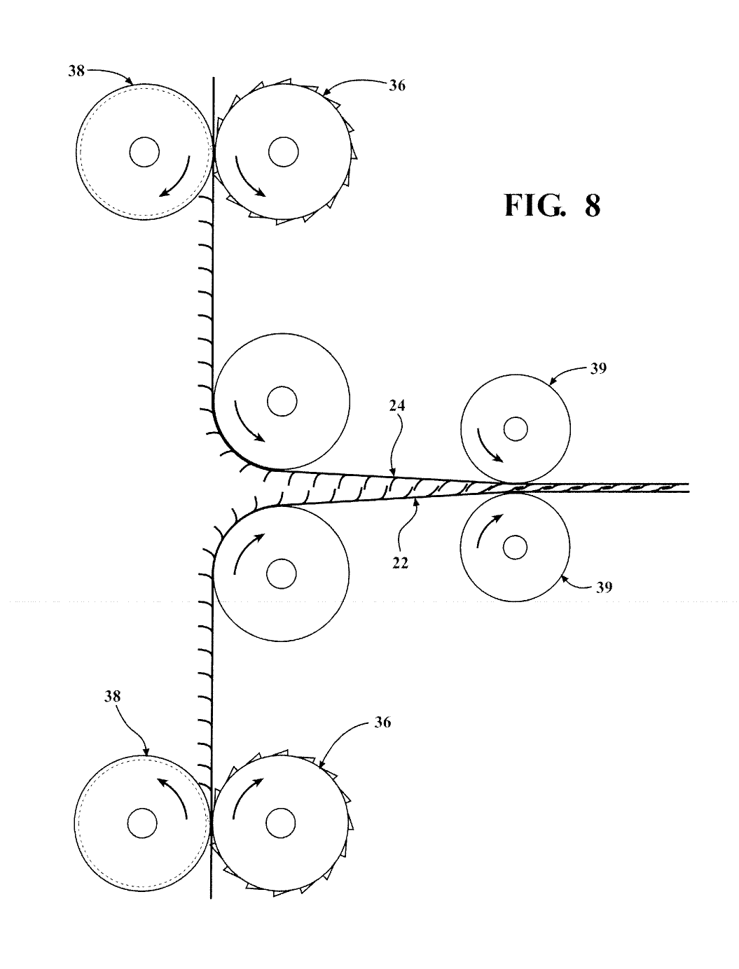

Another aspect of the present invention is for a method for forming a joint between two sheets 22, 24 of material. The method includes the step 100 of punching a plurality of perforations 26, 27, 28, 29 in a first sheet 22 and a second sheet 24 with a tang 30, 31, 32, 33 extending from each of the perforations 26, 27, 28, 29, wherein at least one tang 30, 31 on one of the sheets 22, 24 is a wide tang 30, 31 having a first width W₁ and at least one tang 32, 33 on the other of the sheets 22, 24 is a narrow tang 32, 33 having a second width W₂ which is less than the first width W₁. In the exemplary method, the punching step is further defined as directing a first sheet 22 and a second sheet 24 individually between first and second rollers 36, 38, e.g. the exemplary rollers 36, 38 shown in FIG. 7. As shown, the exemplary first roller 36 includes a plurality of wide punches 40 for punching wide perforations 28, 29 into the sheets 22, 24 to create the wide tangs 30, 31 and a plurality of narrow punches 42 for punching narrow perforations 26, 27 into the sheets 22, 24 to create the narrow tangs 32, 33. Likewise, the exemplary second roller 38 includes a plurality of recesses 44, or grooves, which are aligned with the wide and narrow punches 40, 42 of the first roller 36. It should be appreciated that the tangs 30, 31, 32, 33 could be formed into the first and second sheets 22, 24 through any desirable process including, for example, through punching in a punching press (not shown).

The exemplary method continues with the step 102 of disposing the first and second sheets 22, 24 in parallel relationship with one another. The method then proceeds with the step 104 of inserting the wide tangs 30, 31 of one sheet between the narrow tangs 32, 33 and the remainder of the other sheet 22, 24 and vice versa. In the exemplary embodiment, these steps 102, 104 are accomplished by feeding the first and second sheets 22, 24 between a pair of pressing rollers 39 that are spaced from one another by a predetermined distance. Unlike the first and second rollers 36, 38 which form the tangs 30, 31, 32, 33, the pressing rollers 39 have a generally flat exterior surface to urge the sheets 22, 24 against one another, thereby folding, or bending, the tangs 30, 31, 32, 33 into the configuration shown in FIG. 2. Since the wide tangs 30, 31 are too wide to fit within the narrow perforations 26, 27, the first and second sheets 22, 24 are spaced from one another by an air gap 34 which is sized similarly to the thickness of the wide tangs 30, 31.

The exemplary method then continues with the step 106 of bending the interconnected sheets 22, 24 to a predetermined configuration, such as the heat sink shape shown in FIG. 1. The air gap 34 allows for the bending without crimping or otherwise damaging the sheets 22, 24. Additionally, the tangs 30, 31, 32, 33 are slidable relative to one another, thereby also improving the bending process.

It should also be appreciated that three or more sheets could be joined through the above-described process. In such an embodiment, the tangs of the middle sheet(s) could extend on opposite sides of one another and cooperate with tangs of the above and below sheets.

Obviously, many modifications and variations of the present invention are possible in light of the above teachings and may be practiced otherwise than as specifically described while within the scope of the appended claims.

What is claimed is:

1. A joint between at least two sheets of material comprising:
first and second sheets of material overlying one another and each having a plurality of perforations with a tang extending from each perforation and wherein said tangs of said first sheet cooperate with said tangs of said second sheet to interconnect said first and second sheets;
at least one of said tangs on one of said sheets being a wide tang having a first width and at least one of said tangs on the other of said sheets being a narrow tang having a second width, wherein said first width of said wide tang is greater than said second width of said narrow tang; and
wherein said wide tang and said narrow tang cooperate with one another to interconnect said first and second sheets with a gap provided therebetween.

2. The joint as set forth in claim 1 wherein each of said sheets includes a plurality of wide tangs and a plurality of narrow tangs and wherein said wide tangs of one of said sheets cooperate with said narrow tangs of the other of said sheets.

3. The joint as set forth in claim 2 wherein said wide and narrow tangs of each sheet alternate with one another in a lateral direction across each of said sheets.

4. The joint as set forth in claim 2 wherein said wide and narrow tangs of each sheet alternate with one another in a longitudinal direction across each of said sheets.

5. The joint as set forth in claim 1 wherein said first and second sheets are formed of the same material.

6. The joint as set forth in claim 5 wherein said first and second sheets are formed of metal.

7. The joint as set forth in claim 1 wherein said first and second sheets are formed of different materials.

8. The joint as set forth in claim 1 wherein said interconnected first and second sheets are shaped to form a heat shield for an automobile.

9. A method of forming a joint between at least two sheets of material comprising the steps of:
punching a plurality of perforations in a first sheet and a second sheet with a tang extending from each of the perforations, wherein at least one tang on one of the sheets is a wide tang having a first width and at least one tang on the other of the sheets is a narrow tang having a second width that is less than the first width;
disposing the first and second sheets in parallel relation with one another; and
inserting the wide tang of one sheet between the narrow tang and its sheet to interconnect the first and second sheets.

10. The method as set forth in claim 9 wherein said step of punching the perforations is further defined as directing the first and second sheets individually between a first roller having a plurality of punches and a second roller having at least one recess to receive the punches.

11. The method as set forth in claim 10 wherein the first roller has a plurality of wide punches and a plurality of narrow punches and wherein the second roller has at least one wide recess and at least one narrow recess for receiving the narrow punches.

12. The method as set forth in claim 10 further including the step of inserting each of the wide tangs of each sheet between the narrow tangs of the other sheet.

13. The method as set forth in claim 9 wherein the first and second sheets are formed of the same material.

14. The method as set forth in claim 13 wherein the first and second sheets are formed of metal.

15. The method as set forth in claim 9 wherein the first and second sheets are formed of different materials.

16. The method as set forth in claim 9 further including the step of shaping the interconnected first and second sheets.

17. The method as set forth in claim 16 wherein the step of shaping the interconnected first and second sheets is further defined as shaping the interconnected first and second sheets to form a heat shield.
